(19) United States
(12) Patent Application Publication
(10) Pub. No.: US 2019/0156341 A1
(43) Pub. Date: May 23, 2019

(54) METHOD AND WEB SERVER FOR PROVIDING CARD PAYMENT SIMPLE AUTHENTICATION SERVICE

(71) Applicant: Hyundai Card Co., Ltd., Seoul (KR)

(72) Inventor: Hyun Joo PARK, Seoul (KR)

(21) Appl. No.: 15/866,947

(22) Filed: Jan. 10, 2018

(30) Foreign Application Priority Data
Nov. 23, 2017 (KR) 10-2017-0157392

(51) Int. Cl. G06Q 20/40; G06Q 20/38; G06Q 20/10; G06Q 30/06

(52) U.S. Cl. CPC G06Q 20/4016; G06Q 20/4014; G06Q 30/06; G06Q 20/382; G06Q 20/102; G06Q 20/4018

(57) ABSTRACT

Provided is a method of a card company server simplifying a user identity verification procedure in a card payment, the method including steps of: (a) when a service registration request including card information, ID information, password information, and user terminal identification information are received from a user terminal, matching and storing the pieces of information included in the service registration request; and (b) when a card payment approval request including the stored user terminal identification information is received from the user terminal, performing a process of automatically inputting the ID information into the user terminal.

### CROSS-REFERENCE TO RELATED APPLICATION

This application claims priority to and the benefit of Korean Patent Application No. 2017-0157392, filed on Nov. 23, 2017, the disclosure of which is incorporated herein by reference in its entirety.

### BACKGROUND

### 1. Field of the Disclosure

The present disclosure relates to a method and server for providing a simple card payment authentication service, and more particularly, to a method and server for providing a simple card payment authentication service supporting an automatic input of a part of an ID and a password for verifying an identity of a user registered as an object to be provided with a service when the user attempts a card payment using a terminal possessed by the user so that the card payment is simply completed without the user having to install an additional program and perform an additional authentication procedure.

### 2. Discussion of Related Art

Recently, with activation of electronic commerce, the use of card payments is rapidly increasing to perform transaction in an online (personal computer (PC)) environment or a mobile environment. In this case, a user needs to input a 16 digit card number, a 3 digit card verification value (CVV), and a 6 to 14 digit password for identity verification. Filling in each entry may cause a hassle and inconvenience to a user.

In order to remove such a constraint, card companies have developed various types of simple payment services allowing a user to perform identity verification through a simple procedure.

A representative example of the simple payment services has been developed, and is provided such that when a card payment is performed in an online or mobile environment, once an initial card registration process or a member registration process is completed, a user may complete the payment by only inputting an ID, a 6 digit resident registration number, and a 6 digit personal identification number (PIN) issued through a short message service (SMS) that is transmitted to a mobile terminal in the name of the user. However, the simple payment service still has a hassle in that the user needs to directly fill in a plurality of entries.

In addition, a one-click payment service enabling payment by inputting only an ID and a password with no need to perform a preliminary authentication procedure, such as an SMS authentication, has also been developed, but the one-click payment service is not usable in a mobile environment and is only usable on an affiliate website of a card company

Accordingly, in order to remove the above described constraints, there is a need to simplify a procedure of identity verification for a card payment in an online or mobile environment of a user, and to improve convenience thereof.

### SUMMARY OF THE DISCLOSURE

The present disclosure is directed to providing a method and server for providing a simple card payment authentication service in which a card company server matches and registers card information, ID information, and password information input by a user through a user terminal, and identification information of the user terminal when registering the user as an object to be provided with a service such that at least one of an ID and a password is automatically input during a future card payment using the user terminal, and thus convenience of payment is improved.

In addition, a card payment through a shopping mall website which a user desires to use may be completed without installing an additional program, and thus convenience of payment is further improved.

In addition, whether a requested card payment is a fraudulent payment is determined on the basis of a payment history corresponding to the user when user authentication is performed, and thus security of the card payment is improved.

The technical objectives of the present disclosure are not limited to the above, and other objectives may become apparent to those of ordinary skill in the art based on the following descriptions.

According to one aspect of the present disclosure, there is provided a method of a card company server simplifying a user identity verification procedure in a card payment, the method including steps of: (a) when a service registration request including card information, ID information, password information, and user terminal identification information are received from a user terminal, matching and storing the pieces of information included in the service registration request; and (b) when a card payment approval request including the stored user terminal identification information is received from the user terminal, performing a process of automatically inputting the ID information into the user terminal.

Step (a) may further include: generating a U key by referring to at least one piece of the card information, the ID information, the password information, and the user terminal identification information, and matching and storing the U key, the card information, the ID information, the password information, and the user terminal identification information, and step (b) may further include: transmitting the U key to a fraud detection system (FDS) management server such that the FDS management server determines whether the card payment approval request is a fraudulent transaction.

The FDS management server may transmit a first authentication code indicating that the card payment approval request is a legitimate transaction when it is determined that the card payment approval request is a legitimate transaction, and transmit a second authentication code causing an additional authentication to be further performed by the user terminal when it is determined that the card payment approval request is a fraudulent transaction.

Step (b) may further include: performing an approval process of the card payment without an additional authentication procedure including a process of inputting the ID information when it is determined that the card payment approval request is a legitimate transaction through the FDS management server.

Step (b) may further include automatically inputting the ID information and the password information into the user terminal when a shopping mall through which the card payment is achieved is an affiliate shopping mall of a card company.

The user terminal may transmit the service registration request and the card payment approval request to the card company server through an interface provided by a web page of a shopping mall through which the card payment is achieved.

According to another aspect of the present disclosure, there is provided a card company server for simplifying a user identity verification procedure in a card payment, the card company server includes: a member registration unit configured to, when a service registration request including card information, ID information, password information, and user terminal identification information are received from a user terminal, match and store the pieces of information included in the service registration; and an authentication processor configured to, when a card payment approval request including the stored user terminal identification information is received from the user terminal, performing a process of automatically inputting the ID information into the user terminal.

The member registration unit may be configured to: generate a U key by referring to at least one piece of the card information, the ID information, the password information, and the user terminal identification information; and match and store the U key, the card information, the ID information, the password information, and the user terminal identification information, and the authentication processor may be configured to transmit the U key to a fraud detection system (FDS) management server such that the FDS management server determines whether the card payment approval request is a fraudulent transaction.

The FDS management server may transmit a first authentication code indicating that the card payment approval request is a legitimate transaction when it is determined that the card payment approval request is a legitimate transaction, and transmit a second authentication code causing an additional authentication to be further performed by the user terminal when it is determined that the card payment approval request is a fraudulent transaction.

The authentication processor may perform an approval process of the card payment without an additional authentication procedure including a process of inputting the ID information when it is determined that the card payment approval request is a legitimate transaction through the FDS management server.

The authentication processor may perform a process of automatically inputting the ID information and the password information into the user terminal when a shopping mall through which the card payment is achieved is an affiliate shopping mall of the card company.

The user terminal may transmit the service registration request and the card payment approval request to the card company server through an interface provided by a web page of a shopping mall in which the card payment is achieved

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view illustrating a configuration of a system for providing a simple authentication service according to an embodiment of the present disclosure;

FIG. 2 is a block diagram illustrating a configuration of a card company server according to an embodiment of the present disclosure;

FIG. 3 is a flowchart showing a process in which a user is registered in a simple authentication service according to an embodiment of the present disclosure;

FIG. 4 is a flowchart showing a process in which a card payment is performed through the simple authentication service according to the embodiment of the present disclosure;

FIGS. 5A, 5B and 5C are diagrams illustrating an example in which a popup related to the simple authentication service according to the embodiment of the present disclosure is displayed;

FIG. 6 is a diagram illustrating an example in which a registration interface of the simple authentication service according to the embodiment of the present disclosure is displayed; and

FIG. 7 is a diagram illustrating an example in which a card payment interface of the simple authentication service according to the embodiment of the present disclosure is displayed.

### DETAILED DESCRIPTION OF EXEMPLARY EMBODIMENTS

Hereinafter, embodiments of the present disclosure will be described in detail with reference to the accompanying drawings. The present disclosure may be embodied in various ways, and is not to be construed as limited to the embodiments set forth herein. In the drawings, parts irrelevant to the description have been omitted to clarify the explanation, and the same reference numerals have been used to designate the same elements through the whole specification.

It should be understood that when an element is referred to as being “connected” or “coupled” to another element, the element may be directly or indirectly connected or coupled to the other element, or intervening elements may be present. The terms “comprises,” “includes,” “comprising,” and/or “including” mean that the described components, steps, operations, and/or elements are included and do not preclude the addition or presence of one or more other components, steps, operations, and/or elements unless the context dictates otherwise.

Hereinafter, embodiments of the present disclosure will be described in detail with reference to the accompanying drawings.

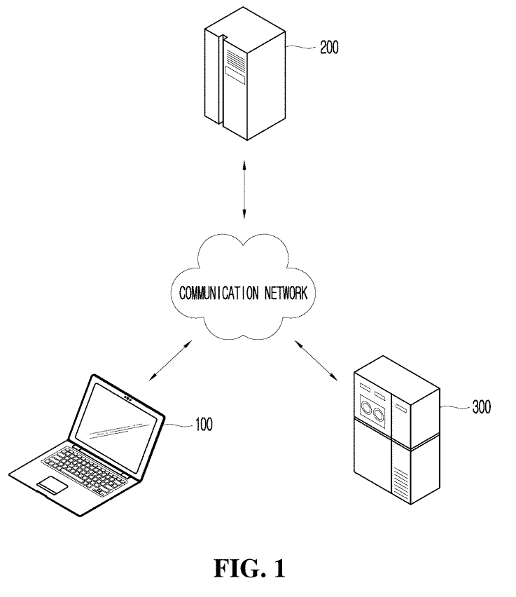

FIG. 1 is a schematic view illustrating a configuration of a system for providing a simple authentication service according to an embodiment of the present disclosure.

Referring to FIG. 1, the system for providing a simple authentication service according to the embodiment of the present disclosure may include a user terminal 100, a card company server 200, and a fraud detection system (FDS) management server 300.

First, the user terminal 100, the card company server 200, and the FDS management server 300 may be connected to each other via a communication network. The communication network may be implemented regardless of a communication manner, such as a wired manner or a wireless manner, in various communication networks, e.g., a local area network (LAN), a metropolitan area network (MAN), a wide area network (WAN), and the like.

The user terminal 100 may include all types of handheld wireless communication devices that are connectable to an external server, such as the card company server 200, via a network, for example, a mobile phone, a smart phone, a personal digital assistant (PDA), a portable multimedia player (PMP), a tablet personal computer (tablet PC), and the like. In addition, the user terminal 100 may include a communication device connectable to an external server, such as the card company server 200, via a network, for example, a desktop PC, a tablet PC, a laptop PC, and an IP television (IPTV) including a set top box.

In addition, the user terminal 100 may include all types of devices capable of running an application and accessing the Internet.

The user terminal 100 according to the embodiment of the present disclosure may execute a web browser installed on the user terminal 100 and request a web page provided by a shopping mall server (not shown) or the card company server 200 according to a manipulation of a user.

The requesting of a web page may be achieved through various methods such as inputting an address of a web page, selecting a link on a certain web page, and executing a search request in a web page that provides a search service.

The card company server 200 may be a server that issues a card to a user and processes a payment request with regard to the card being used.

The card company server 200 may receive a service registration request including user related information that is input by a user from the user terminal (card information, ID information, password information, and the like), and identification information of the user terminal 100 collected by the user terminal 100 itself (the type, version, and language information of a web browser being used, a platform, a type of central processing unit (CPU), language information of a system, size and resolution information of a display, a media access control (mac) address, a hard serial number, an Internet protocol (IP), proxy OP information of the user terminal 100, and the like).

Accordingly, the card company server 200 matches and stores the user related information and the identification information of the user terminal 100 in a database of the card company server 200 to register the user as an object to be provided with a simple authentication service.

In addition, the card company server 200 may generate an identification code (hereinafter, a U key) corresponding to the user when the user is registered, and may match and store the identification code and the registered pieces of information in an internal database.

The card company server 200 may determine whether identification information of the user terminal 100 is registered in the database when a card payment approval request is received from the user terminal 100, and, when the identification information of the user terminal 100 is registered in the database, allow one of the ID and password of the user corresponding to the identification information to be automatically input into the user terminal 100.

In addition, the card company server 200 may send the FDS management server 300 information about the U key matching the identification information of the user terminal together with information about the card payment approval request, and may receive an authentication code regarding a result of determining whether the card payment is a fraudulent payment from the FDS management server 300.

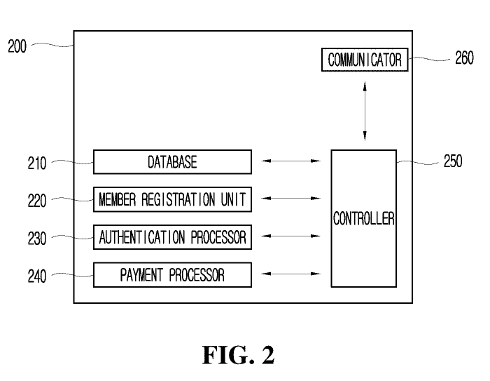

In this case, the card company server 200 may perform an additional authentication procedure by receiving an input of a personal identification number (PIN) having a predetermined length from a user through the user terminal 100 or receiving an input of a certain number through an automatic response service (ARS) when the received authentication code is an authentication code indicating that a fraudulent payment is suspected and a need for additional authentication. Details thereof will be described below with reference to FIG. 2.

The card company server 200 may perform an approval process such that the card payment approval request is approved when identity verification is completed via the ID and password of the user (and with a predetermined additional authentication procedure when the FDS management server 300 determines that a card payment is a fraudulent payment).

The FDS management server 300 may be a server that manages an FDS.

The FDS represents a system that collects a log of terminal access information used for an electronic financial transaction (terminal device system information, network information, IP access information, transaction history, and the like), identifies a suspect transaction through analysis, and blocks the transaction, that is, a system for determining whether a financial incident occurs when a transaction having a pattern different from a normal payment pattern of a user is found and stopping the transaction.

The FDS management server 300 may be configured to determine whether a card payment approval request is a fraudulent payment on the basis of an existing payment history and pattern information of a user corresponding to a U key when information about the U key and information about the card payment approval request is received from the card company server 200.

The FDS management server 300 may be configured to send the card company server 200 a legitimate transaction authentication code indicating that the card payment approval request is a legitimate transaction when it is determined that the card payment approval request is a legitimate transaction as a result of the determination, and, when it is determined that the card payment request is a fraudulent transaction, send the card company server 200 a fraudulent transaction authentication code indicating that the card payment approval request is a fraudulent transaction.

As described above, in the specification, the card company server 200 and the FDS management server 300 are illustrated as being separately implemented, but the present disclosure is not limited thereto. For example, the card company server 200 and the FDS management server 300 may be implemented as a single element to perform the respective functions thereof.

FIG. 2 is a block diagram illustrating a configuration of the card company server 200 according to the embodiment of the present disclosure.

Referring to FIG. 2, the card company server 200 according to the embodiment of the present disclosure may include a database 210, a member registration unit 220, an authentication processor 230, a payment processor 240, a controller 250, and a communicator 260.

The database 210 may be configured to store various pieces of information related to the simple authentication service according to the present disclosure.

According to the embodiment, the database 210 may be configured to store the user related information and the identification information about the user terminal 100, which are collected through the member registration unit 220, and U key information generated for a corresponding user such that the user related information and identification information about the user terminal 100 match the U key information.

In addition, the database 210 may be configured to store information about a shopping mall in which a user performs a card payment transaction and information about a transaction history corresponding to the transaction.

The member registration unit 220 may register a user as an object to be serviced on the basis of a service registration request received from the user terminal 100.

In detail, the member registration unit 220 may receive the service registration request including the user related information and the identification information of the user terminal 100 from the user terminal 100.

Then, the member registration unit 220 may send the user terminal 100 a request for user identity verification using one of PIN authentication, ARS authentication, and certificate authentication, and generate a U key corresponding to the user by referring to at least one of the user related information and the identification information of the user terminal 100 when the identity verification is completed through the user terminal 100.

Accordingly, the member registration unit 220 may match and store the user related information, the identification information of the user terminal 100, and the U key in the database 210, and send the FDS management server 300 the user related information, the identification information of the user terminal 100, and the U key that match each other.

The member registration unit 220 according to the embodiment may be configured to determine whether an ID and a password corresponding to the user related information are stored in the database 210 when a service registration request is received from the user terminal 100, and, when the ID and the password are previously stored in the database 210, the member registration unit 220 may complete a procedure of registering a service object by only matching and storing the identification information of the user terminal 100 according to the service registration request and the previously stored user related information.

The authentication processor 230 may perform an authentication procedure for the card payment approval request received from the user terminal 100.

In detail, according to the embodiment, the user terminal 100 may be configured to select the simple payment service according to the present disclosure among options on a payment page provided by a specific shopping mall website when a product (or a service) is intended to be purchased using a card payment through the shopping website due to a manipulation of a user, and in the selection, a predetermined ID and password input interface may be displayed on a screen of the user terminal 100.

In this case, the authentication processor 230 may receive a card payment approval request including transaction information (information about an item to be purchased, price information, information about a shopping mall, and the like) and identification information of the user terminal 100 from the user terminal 100.

The authentication processor 230 according to the embodiment may determine whether the identification information of the user terminal 100 is registered in the database 210, and send ID information of a user corresponding to the identification information of the user terminal 100 to the user terminal 100 such that the ID information is automatically input into the ID and password input interface displayed on the user terminal 100 when the identification information of the user terminal 100 is registered in the database 210.

Accordingly, the user terminal 100 may perform a payment procedure by only receiving an input of a password from the user.

In addition, according to the embodiment of the present disclosure, when a shopping mall in which a transaction is achieved is an affiliate shopping mall with a partnership contract with the card company, the authentication processor 230 may send the user terminal 100 ID information and password information corresponding to the identification information of the user terminal 100 such that the ID information and password information are automatically input into the ID and password input interface.

As the inputs of the ID and password are completed in this manner, the user terminal 100 may perform the payment procedure without any input received from the user.

That is, with the simple authentication service according to the present disclosure, a user is only required to fill in one entry at the most for a card payment, and thus the payment procedure is significantly simplified in comparison to an existing technology requiring the user to fill in a plurality of entries, and convenience of using a service is remarkably improved.

The authentication processor 230 according to the embodiment of the present disclosure may be configured to search for U key information corresponding to the identification information of the user terminal 100 in the database 210 when a card payment approval request is received, and send information about the card payment approval request and the U key information to the FDS management server 300.

The FDS management server 300 according to the embodiment may collect existing card payment history information corresponding to the U key by itself or through the card company server 200, and determine whether the card payment approval request is a fraudulent transaction on the basis of existing card payment history information.

Accordingly, the FDS management server 300 according to the embodiment may be configured to send the authentication processor 230 a first authentication code indicating that the card payment approval request is a legitimate transaction when the card payment approval request is a legitimate transaction, and send the authentication processor 230 a second authentication code indicating that the card payment approval request is a fraudulent transaction when the card payment approval request is a fraudulent transaction.

The authentication processor 230 may be configured to cause the payment processor 240 to approve and process the card payment by only completing the above described authentication process of the identification information of the user terminal 100 when the first authentication code is received from the FDS management server 300.

In this case, according to another embodiment of the present disclosure, an authentication processor 230 may be configured to omit the above described process of inputting an ID and a password and cause a card payment to be subject to approval processing when a first authentication code is received from a FDS management server 300.

Meanwhile, the authentication processor 230 may be configured to cause the card payment to be subject to approval processing only when an additional authentication procedure is completed after the completion of the above described authentication process of the identification information of a user terminal 100 when the second authentication code is received from the FDS management server 300.

For example, the authentication processor 230 may be configured to send a message including a number having a predetermined length to the user terminal 100 and directly receive the number having the predetermined length from the user through the user terminal 100 to cause the card payment to be subject to approval processing when the second authentication code is received from the FDS management server 300. Alternatively, the authentication processor 230 may directly receive a number having a predetermined length, which is directed to the user terminal 100 using an ARS, from the user through the user terminal 100 to cause the card payment to be subject to approval processing.

That is, a card company server 200 may further check for the occurrence of a fraudulent transaction of the card payment in addition to checking for authentication of the identification information of the user terminal 100, and thus service security is improved.

A payment processor 240 may approve or deny the card payment depending on a result of authenticating the card payment approval request by the authentication processor 230.

In other words, the payment processor 240 may be configured to approve the card payment when authentication of the card payment approval request is completed by the authentication processor 230, and deny the card payment when the authentication of the card payment approval request is not completed or failed by the authentication processor 230.

The controller 250 according to the embodiment may serve to control a data flow between the database 210, the member registration unit 220, the authentication processor 230, the payment processor 240, and the communicator 260. That is, the controller 250 according to the embodiment of the present disclosure may perform control such that the database 210, the member registration unit 220, the authentication processor 230, the payment processor 240, and the communicator 260 each perform a function.

The communicator 260 according to the embodiment enables communication between the card company server 200, an external service, and an external device. In detail, the communicator 260 enables the card company server 200 to communicate with the user terminal 100 and the FDS management server 300.

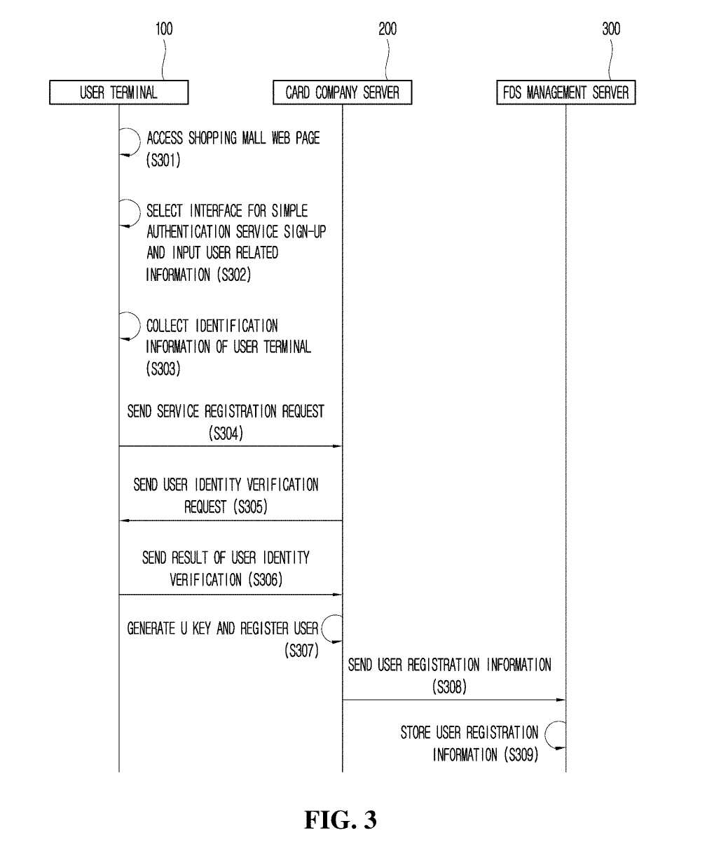

FIG. 3 is a flowchart showing a process in which a user is registered in the simple authentication service according to the embodiment of the present disclosure.

First, the user terminal 100 may access a shopping mall web page due to a manipulation of a user (S301) and select a predetermined product or service desired to be purchased.

Then, when a payment for the selected product or service is intended to be performed, an interface related to a payment method using a simple authentication service may be displayed on the user terminal 100, and the user terminal 100 may receive an input selecting an interface for signing up on the simple authentication service from the user through the interface and receive an input of user related information, such as card information, ID information, password information, and the like, from the user through the interface (S302).

In addition, the user terminal 100 according to the embodiment may collect identification information of the user terminal 100, such as the type, version, and language information of a web browser of the user terminal 100, a platform, a type of CPU, and language information of a system, size and resolution information of a display, a mac address, a hard serial number, an IP, proxy OP information of the user terminal 100, and the like, by itself (S303).

Accordingly, the user terminal 100 transmits a service registration request including the user related information collected in operation S302 and the identification information of the user terminal 100 collected in operation S303 to the card company server 200 (S304).

The card company server 200 may receive the service registration request through operation S304 and request a user identity verification from the user terminal 100 (S305), and the user terminal 100 may complete the user identify verification by using one of a PIN authentication in which a PIN (i.e., a number having a predetermined length), which sent through a short message service (SMS) is received from the user, an ARS authentication in which a predetermined number is received from the user through an ARS, a certificate authentication using a certificate in the name of the user, and the like, and may send a result of the authentication to the card company server 200 (S306).

The card company server 200 may receive the result of the user identity verification, generate a U key corresponding to the user, and match and store the U key and the user related information and identification information of the user terminal 100 received through operation S304 in the internal database to register the user as an object to be provided with a simple authentication service (S307).

Then, according to the embodiment, the card company server 200 may send the user registration information stored in the database through operation S307 to the FDS management server 300 (S308), and the FDS management server 300 may store the user registration information in the internal database (S309) so that the FDS management server 300 may search for a user corresponding to a certain piece of U key information when the certain piece of U key information is received from the card company server 200 at a later time, and determine whether a fraudulent transaction related to the user occurs.

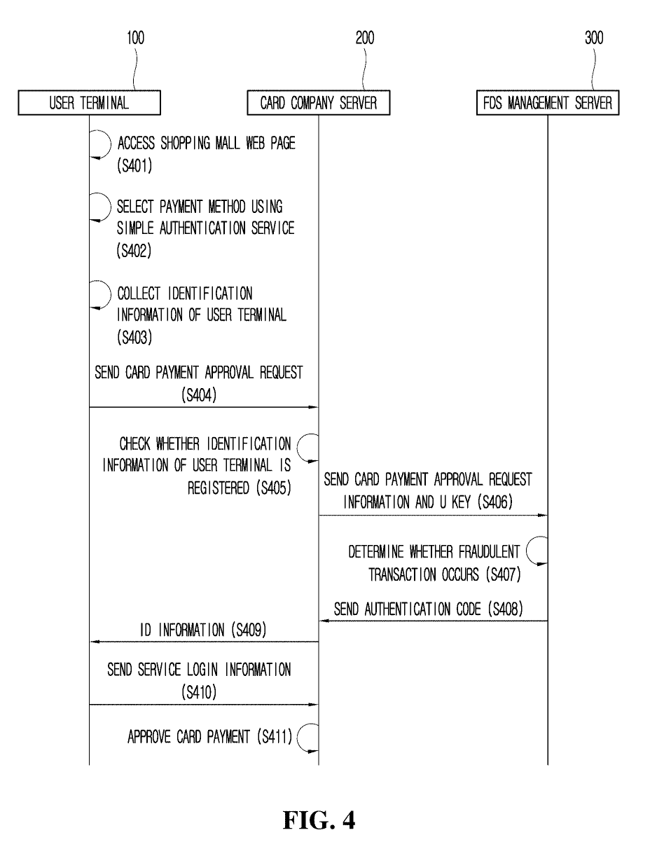

FIG. 4 is a flowchart showing a process in which a card payment is performed through the simple authentication service according to the embodiment of the present disclosure.

First, the user terminal 100 may access a shopping mall web page by a manipulation of a user (S401), and a payment method using a simple authentication service may be selected through a payment method selection interface displayed on a screen of the user terminal 100 when a payment for a predetermined product or service desired to be purchased is intended to be performed (S402).

Accordingly, the user terminal 100 according to the embodiment may collect identification information of the user terminal 100, such as the type, version, and language information of a web browser being used by the user terminal 100, a platform, a type CPU, and language information of a system, size and resolution information of a display, a mac address, a hard serial number, an IP address, proxy OP information of the user terminal 100, and the like, by itself (S403).

Then, the user terminal 100 may send the card company server 200 a card payment approval request including transaction information, including information about an item to be purchased, price information, information about a shopping mall, and the identification information of the user terminal 100 collected through operation S403 (S404).

The card company server 200 may check whether the identification information of the user terminal 100 is registered in an internal database according to the card payment approval request received through operation S404 (S405), and send the FDS management server 300 U key information corresponding to the identification information together with the card payment approval request information when the identification information of the user terminal 100 is registered in the internal database (S406).

The FDS management server 300 may determine whether the card payment approval request is a fraudulent transaction by referring to existing card payment history information of a user corresponding to the U key received through operation S406 (S407), and send the card company server 200 an authentication code regarding a result of the determination (S408).

In detail, the FDS management server 300 may send the card company server 200 a first authentication code indicating that the card payment approval request is a legitimate transaction when the card payment approval request is a legitimate transaction, and send the card company server 200 a second authentication code indicating that the card payment approval request is a fraudulent transaction when the card payment approval request is a fraudulent transaction.

Then, the card company server 200 may send ID information of the user corresponding to the identification information of the user terminal 100 to the user terminal 100 when the authentication code received through operation S408 is the first authentication code (S409) such that the ID information is automatically input into an ID and password input interface displayed on the user terminal 100.

Accordingly, the user terminal 100 receives an input of a password from the user and sends the card company server 200 service login information including the ID information and password information of the user (S410).

In addition, according to the embodiment of the present disclosure, a shopping mall in which a transaction is achieved is an affiliate shopping mall with a partnership contract with the card company, the card company server 200 may send the user terminal 100 ID information and password information corresponding to the identification information of the user terminal 100 such that the ID information and password information are automatically input to the ID and password input interface.

As the inputs of the ID and password are completed in this manner, the user terminal 100 may perform Operation 410 without any input received from the user.

In this case, according to another embodiment of the present disclosure, a card company server 200 may allow operation S411 to be immediately performed by omitting operation S409 and operation S410 when a first authentication code is received from a FDS management server 300 in operation S408.

Accordingly, a user is only required to fill in one entry at the most for a card payment, and thus a payment procedure is significantly simplified in comparison to the existing technology requiring the user to fill in a plurality of entries, and thus convenience of using a service is remarkably improved.

Meanwhile, according to the embodiment, when the authentication code received through operation S408 is the second authentication code, the card company server 200 may cause the user terminal 100 to further perform a user identity verification using one of a PIN authentication, an ARS authentication, a certificate authentication, and the like after operation S410.

Then, the card company server 200 may perform approval processing on the card payment approval request received in operation S404 (S411).

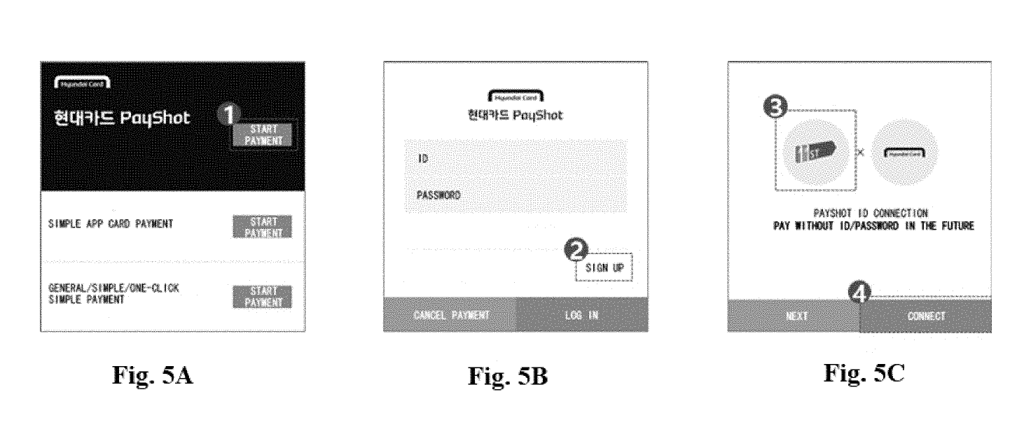

FIGS. 5A, 5B and 5C are diagrams illustrating an example in which a popup related to the simple authentication service according to the embodiment of the present disclosure is displayed.

According to the embodiment, the user terminal 100 may access a shopping mall website selling a predetermined product or service according to a manipulation of a user, and when a payment of a price of the product or service is intended to be performed with a card, a popup allowing a payment method to be selected is displayed on the shopping mall website, as shown in FIG. 5A.

In this case, the user terminal 100 may receive a selection of a button for using a simple authentication service according to the present disclosure from a user, as shown in \textcircled{1}, and thus a payment procedure of the simple authentication service is performed.

When the button in \textcircled{1} is selected, an ID and password input interface is displayed on the user terminal 100 as shown in FIG. 5B, the user terminal 100 may receive an input of at least one of an ID and a password, which are input by the user when signing up for the simple authentication service, through the card company server 200.

In this case, when the user is not signed up for the simple authentication service, the user terminal 100 may receive an input selecting a button shown in \textcircled{2} from the user, and thus a procedure of signing up for the simple authentication service is performed.

According to the embodiment, when the shopping mall website is an affiliate shopping mall website with a partnership contract with the card company, the above-described login procedure according to the inputs of the ID and password is completed, and then a popup for associating an affiliate website account of the user with a simple authentication service account of the user may be displayed on the user terminal 100, as shown in FIG. 5C.

On the popup, a brand image of the affiliate web site may be displayed as shown in \textcircled{3}, and the user terminal 100 may receive an input of a button shown in \textcircled{4} being selected by the user, receive an ID and a password of the affiliate website, and send the received ID and password of the affiliate website to the card company server 200 such that the affiliate website account of the user is associated with the simple authentication service account of the user through the card company server 200.

According to the embodiment of the present disclosure, a user may perform a payment process using the simple authentication service according the present disclosure through a popup provided through the shopping mall website in which the user desires to purchase a product or service, obviating the need to install an additional program, and thus remarkably improving convenience of payment.

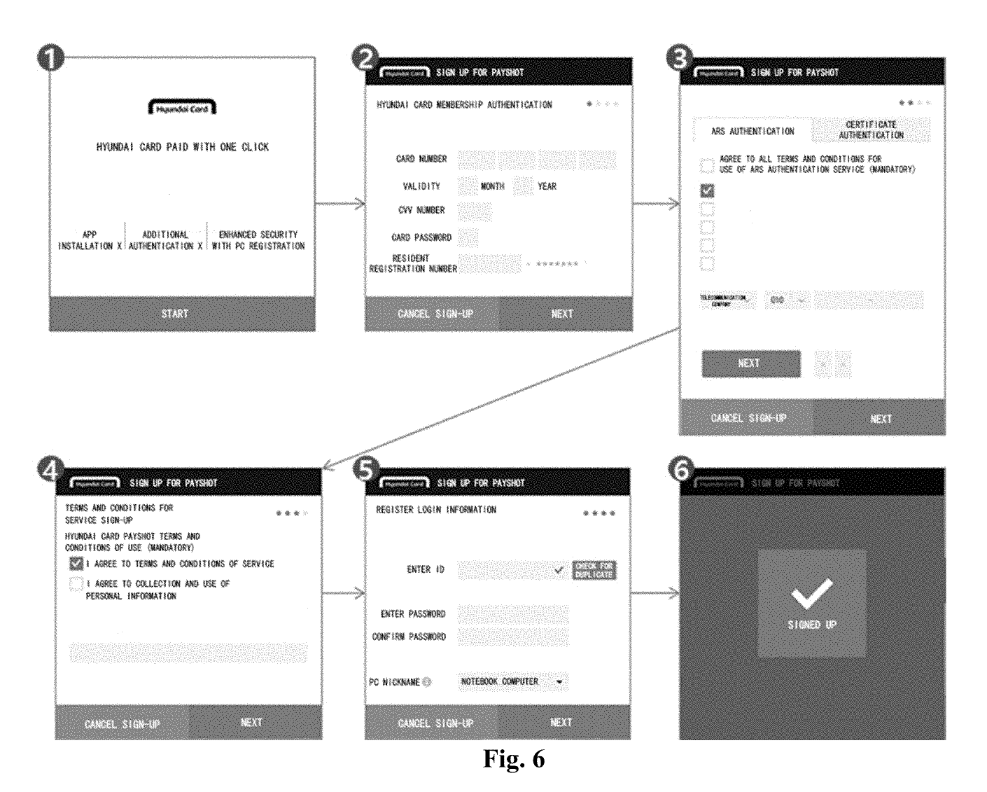

FIG. 6 is a diagram illustrating an example in which a registration interface of the simple authentication service according to the embodiment of the present disclosure is displayed.

First, when the user terminal 100 receives an input of the button \textcircled{2} in FIG. 5B being selected by a user, a popup providing guidance for a simple authentication service may be displayed on a screen of the user terminal 100, as shown in \textcircled{1}.

Then, the user terminal 100 may receive an input of card information, such as a card number, an expiration date, a CVV number, a part of a password, and a part of a resident registration number, from the user through an interface shown in \textcircled{2}.

After the card information is input, an interface for performing identity verification may be displayed on the screen of the user terminal 100, as shown in \textcircled{3}, and the user identity verification may be performed using an ARS authentication, a certificate authentication, a PIN authentication using an SMS, and the like.

After the identity verification is completed, an interface for obtaining an agreement with simple authentication service sign-up terms and conditions from the user may be displayed on the screen of the user terminal 100, as shown in \textcircled{4}, and an interface for inputting an ID and a password that are used when using the simple authentication service may be displayed as shown in \textcircled{5} when the user inputs his or her agreement with the sign-up terms and conditions.

Then, when the inputs of the ID and password are completed, a popup indicating that the sign-up for the simple authentication service is completed may be displayed on the screen of the user terminal 100, as shown in \textcircled{5}.

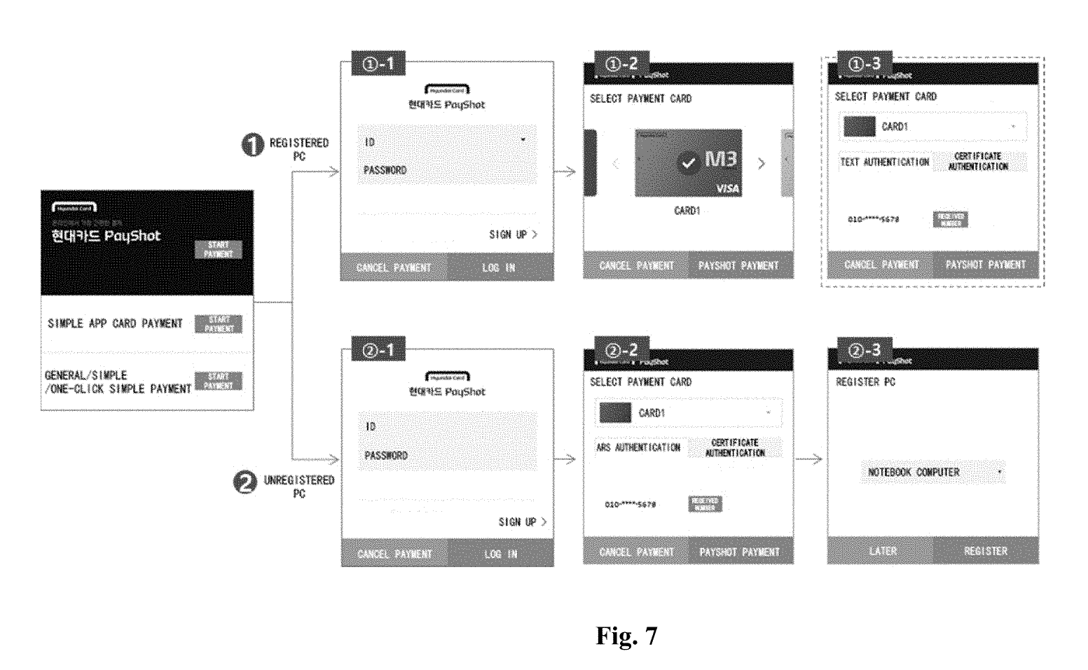

FIG. 7 is a diagram illustrating an example in which a card payment interface of the simple authentication service according to the embodiment of the present disclosure is displayed.

According to the embodiment of the present disclosure, when a payment method using a simple authentication service is selected by a user on a certain shopping website, the user terminal 100 may collect identification information of the user terminal 100 by itself, and may send the card company server 200 a card payment approval request including the collected identification information of the user terminal 100 and information on a transaction which the user desires to pay. When the card company server 200 determines that the user terminal 100 is a previously registered terminal (\textcircled{1}), an ID of the user may be automatically input into an ID and password input interface as shown in \textcircled{1}−1, and thus the user terminal 100 may proceed with the next operation by only receiving an input of a password from the user.

In this case, when the shopping mall through which the transaction is achieved is an affiliate shopping mall of the card company, both the ID and the password may be automatically input into the ID and password input interface.

Then, the user terminal 100 may display card information of the user corresponding to the ID and password input in \textcircled{1}−1 as shown in \textcircled{1}−2, and may perform a card payment with respect to the transaction by using a card selected by the user.

In addition, according to the embodiment of the present disclosure, when the FDS management server 300 determines that the transaction is a fraudulent transaction or a price of the transaction exceeds a predetermined amount, the user terminal 100 may further display an interface for performing an additional authentication procedure using an SMS, a certificate, and the like, as shown in \textcircled{1}−3. In this case, the card payment is performed only when the additional authentication procedure is completed.

Meanwhile, when the card company server 200 determines that the user terminal 100 is a terminal not previously registered (\textcircled{2}), the user terminal 100 may receive both inputs of the ID and the password from the user through an interface shown in \textcircled{2}−1, and may then receive an input selecting a card to be used for the transaction among cards corresponding to the ID and password and perform a user identity verification procedure by using an ARS authentication, a certificate authentication, and the like through an interface shown in \textcircled{2}−2. In this case, according to an embodiment, when the card payment is completed through \textcircled{2}−2, the user terminal 100 may display an interface through which the user terminal 100 may immediately be registered as a terminal to be provided with a simple authentication service, as shown in \textcircled{2}−3, and the user terminal 100 may thus be registered as the terminal to be provided with a simple authentication service without an additional authentication procedure.

As described above, according to the embodiment of the present disclosure, when registering a user as an object to be provided with a service, a card company server card matches and registers card information, ID information, and password information input through a user terminal from the user, and identification information of the user terminal such that at least one of an ID and a password is automatically input in a future card payment using the user terminal, and thus convenience of payment is improved.

According to the embodiment of the present disclosure, a card payment through a shopping mall website which a user desires to use may be completed without installing an additional program, and thus convenience of payment is further improved.

According to the embodiment of the present disclosure, when user authentication is performed, whether a requested card payment is a fraudulent payment is determined on the basis of a payment history corresponding to the user, and thus security of the card payment is improved.

It should be understood that the advantageous effects of the present disclosure are not limited to the above, and all other effects that may be deduced from constructions disclosed in the specification or the scope of claims of the present disclosure are included therein.

The above description of the present disclosure is for illustrative purposes, and a person having ordinary skilled in the art should appreciate that other specific modifications may be easily made without departing from the technical spirit or essential features of the present disclosure. Therefore, the above embodiments should be regarded as illustrative rather than limitative in all aspects. For example, components which have been described as being a single unit may be embodied in a distributed form, and components which have been described as being distributed can be embodied in a combined form.

The scope of the present disclosure is not defined by the detailed description set forth above but by the accompanying claims of the present disclosure. It should also be understood that all changes or modifications derived from the definitions and scope of the claims and their equivalents fall within the scope of the present disclosure.

What is claimed is:

1. A method of a card company server simplifying a user identity verification procedure in a card payment, the method comprising steps of:
(a) when a service registration request including card information, ID information, password information, and user terminal identification information are received from a user terminal, matching and storing the pieces of information included in the service registration request; and
(b) when a card payment approval request including the stored user terminal identification information is received from the user terminal, performing a process of automatically inputting the ID information into the user terminal.

2. The method of claim 1, wherein:
step (a) further comprises generating a U key by referring to at least one piece of the card information, the ID information, the password information, and the user terminal identification information, and matching and storing the U key, the card information, the ID information, the password information, and the user terminal identification information; and
step (b) further comprises transmitting the U key to a fraud detection system (FDS) management server such that the FDS management server determines whether the card payment approval request is a fraudulent transaction.

3. The method of claim 2, wherein the FDS management server transmits a first authentication code indicating that the card payment approval request is a legitimate transaction when it is determined that the card payment approval request is a legitimate transaction, and transmits a second authentication code causing an additional authentication to be further performed by the user terminal when it is determined that the card payment approval request is a fraudulent transaction.

4. The method of claim 2, wherein step (b) further comprises performing an approval process of the card payment without an additional authentication procedure including a process of inputting the ID information when it is determined that the card payment approval request is a legitimate transaction through the FDS management server.

5. The method of claim 1, wherein step (b) further comprises automatically inputting the ID information and the password information into the user terminal when a shopping mall through which the card payment is achieved is an affiliate shopping mall of a card company.

6. The method of claim 1, wherein the user terminal transmits the service registration request and the card payment approval request to the card company server through an interface provided by a web page of a shopping mall through which the card payment is achieved.

7. A card company server for simplifying a user identity verification procedure in a card payment, the card company server comprising:
a member registration unit configured to, when a service registration request including card information, ID information, password information, and user terminal identification information are received from a user terminal, match and store the pieces of information included in the service registration request; and
an authentication processor configured to, when a card payment approval request including the stored user terminal identification information is received from the user terminal, perform a process of automatically inputting the ID information into the user terminal.

8. The card company server of claim 7, wherein:
the member registration unit generates a U key by referring to at least one piece of the card information, the ID information, the password information, and the user terminal identification information, and matches and stores the U key, the card information, the ID information, the password information, and the user terminal identification information, and
the authentication processor transmits the U key to a fraud detection system (FDS) management server such that the FDS management server determines whether the card payment approval request is a fraudulent transaction.

9. The card company server of claim 8, wherein the FDS management server transmits a first authentication code indicating that the card payment approval request is a legitimate transaction when it is determined that the card payment approval request is a legitimate transaction, and transmits a second authentication code causing an additional authentication to be further performed by the user terminal when it is determined that the card payment approval request is a fraudulent transaction.

10. The card company server of claim 8, wherein the authentication processor performs an approval process of the card payment without an additional authentication procedure including a process of inputting the ID information when it is determined that the card payment approval request is a legitimate transaction through the FDS management server.

11. The card company server of claim 7, wherein the authentication processor performs a process of automatically inputting the ID information and the password information into the user terminal when a shopping mall through which the card payment is achieved is an affiliate shopping mall of the card company.

12. The card company server of claim 7, wherein the user terminal transmits the service registration request and the card payment approval request to the card company server through an interface provided by a web page of a shopping mall through which the card payment is achieved.
